(19) United States
(12) Patent Application Publication
(10) Pub. No.: US 2002/0136466 A1
(43) Pub. Date: Sep. 26, 2002

(54) Image display apparatus

(76) Inventors: Yugi Yata, Amagasaki-shi (JP); Hisae Tsuruta, Amagasaki-shi (JP); Koichi Sato, Amagasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/053,600

(22) Filed: Jan. 24, 2002

(30) Foreign Application Priority Data
Mar. 23, 2001 (JP) 2001-85404

(51) Int. Cl. G06K 9/20

(52) U.S. Cl. 382/282

(57) ABSTRACT

An image displaying apparatus has a data- storage section for storing a radiograph and other image data, and an image display section for displaying a specified image data which is read out from the data- storage section, wherein an image reading window is formed on a display screen of the image displaying section for displaying an image of a target region to be diagnosed or to be trace-read, and an image-reading-window setting means is provided for not displaying an image other than the target region to be diagnosed or to be trace-read.

### BACKGROUND OF THE INVENTION

1. Field of the Invention

The present invention relates to an image displaying apparatus, more precisely relates to a radiation image displaying apparatus for displaying only a target region to be diagnosed and to be traced on a “image reading window”, with masking luminescence of the region which has no interest for the operator.

2. Prior Art of the Invention

Conventionally, when an image diagnosis of a radiograph is conducted, diagnosis or image reading is carried out by placing films on the Schaukasten or by displaying a digital radiographs on a screen of a display device. There is a problem that Schaukasten and display devices are light emitting instruments so that gradation or tone of the image to be diagnosed tends to be changed in line with the luminance of light from outside. Therefore, the Schaukasten or the display device has been used in a dark room in which light from an outside can be shade as much as possible.

When an image is displayed on a display device, usually a digital image is used and processed.

There have been some problems in the conventional image diagnosis or trace reading. These problems are as follows.

(1) When an image diagnosis of a radiograph is carried out in a dark room, there is a possibility that misdiagnosis or deterioration in accuracy of diagnosis tends to be occurred, due to the luminescence at the outside of the target region to be diagnosed or trace-read.

(2) In order to solve the problems (1) mentioned above, there is a necessity that the light from the outside of the target region on the Schaukasten or the display device should be shade artificially such as by using a hand or a piece of paper.

(3) When nearly symmetrical radiograph such as chest radiographs are diagnosed, contradistinguish between the right and the left portion of the image are carried out with eye, or carried out using a hand or a piece of paper, thereby causing deterioration in accuracy of diagnosis.

### SUMMARY OF THE INVENTION

An object of the present invention is to provide an apparatus for displaying an image, especially a radiograph, more precisely to provide an image display apparatus capable of displaying only a target region to be diagnosed or to be trace-read.

A feature of the image displaying apparatus of the present invention is that the apparatus has a data-storage section for storing a radiograph and other image data, and an image display section for displaying a specified image data which is read from the data-storage section, wherein an image reading window is formed on a display screen of the image displaying section for displaying an image of a target region to be diagnosed or to be trace-read, and an image-reading-window setting means is provided for not displaying an image other than the target region to be diagnosed or to be trace-read.

According to the feature mentioned above, though the radiograph and the other images are displayed on the display device, the luminescence of the image except the target region is masked, so that bad effects derived from the light from the region other than the target region to be diagnosed or to be traced can be effectively decreased. Therefore, accuracy of the image diagnosis of a radiograph can be enhanced.

Another feature of the apparatus of the present invention is that the apparatus is further comprised of image-reading-window shifting means for shifting a setting position of the image reading window formed on the display screen.

According to the feature mentioned above, a region of the image wanted to be checked can be easily checked or trace-read.

Another feature of the apparatus of the present invention is that the apparatus has an image-reading-window-size changing means for changing a size of the image reading window formed on the display screen.

According to the feature mentioned above, efficient image reading can be achieved by adjusting the size of the region to be checked to a necessary and sufficient one.

Another feature of the apparatus of the present invention is that the apparatus has further an image-reading-window-shape changing means for changing the shape of the image reading window formed on the display screen.

According to the feature mentioned above, efficient image reading can be achieved by adjusting the shape of the image reading window to the region to be checked.

Still another feature of the apparatus of the present invention is that the shape of the image reading window, the shape of which is controlled by the image-reading-window setting means, is rectangular.

According to the feature mentioned above, the image reading window can be used as a scale to measure the displayed image. Therefore, physical relationship in a direction of right and left or upper and lower in relation to a portion to be diagnosed, as well as dissimilarities between symmetrical right and left portions, can be easily found out.

Still another feature of the apparatus of the present invention is that the apparatus further comprises an image processing means for processing an image data that is used for displaying an image on the screen of the image reading window.

According to the feature mentioned above, the processing times for processing the image data in the image reading window can be made shorter when compared with that for processing full picture on the display screen. Therefore, throughput for an image diagnosis can be improved as a whole.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is a block diagram showing construction of an image display apparatus of an embodiment of the present invention;

FIG. 2 is a picture of a chest radiograph without setting up an image reading window;

FIG. 3 is a picture of another chest radiograph without setting up an image reading window;

FIG. 4 is a picture of a chest radiograph of FIG. 2 with setting up the image reading window;

FIG. 5 is a picture of a chest radiograph of FIG. 3 with setting up the image reading window;

FIG. 6 is a picture of a chest radiograph before the image reading window is shifted;

FIG. 7 is a picture of the chest radiograph of FIG. 6 after the image reading window is shifted;

FIG. 8 is a picture of a chest radiograph before the size of the image reading window is changed;

FIG. 9 is a picture of a chest radiograph of FIG. 8 after the size of the image reading window is changed;

FIG. 10 is a picture of a chest radiograph before the shape of the image reading window is changed;

FIG. 11 is a picture of a chest radiograph of FIG. 10 after the shape of the image reading window is changed;

FIG. 12 is a picture of a chest radiograph image before the image displayed on the image reading window is image-processed; and

FIG. 13 is a picture of a chest radiograph of FIG. 12 after the image is image-processed.

### DESCRIPTION OF THE PREFERRED EMBODIMENTS

Preferred embodiments of the present invention will be described hereunder with reference to the accompanying drawings.

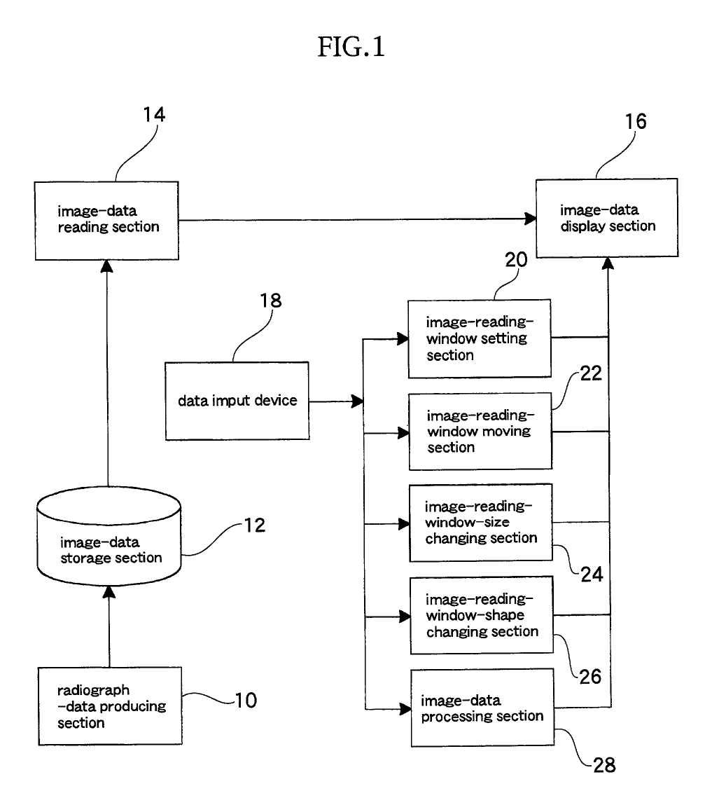

The embodiment of the present invention will be described hereunder with reference to FIG. 1 to FIG. 13.

FIG. 1 is a block diagram showing construction of an image displaying apparatus of an embodiment of the present invention. The image displaying apparatus of the present invention comprises radiograph -data producing section 10, image-data storage section 12, image-data reading section 14, image-data display section 16, data input device 18, image-reading-window setting section 20, image-reading-window shifting section 22, image-reading-window-size changing section 24, image-reading-window-shape changing section 26, and image-data processing section 28.

Radiograph-data producing section 10 is a section for digitizing a photographed radiograph . The digital radiograph at radiograph-data producing section 10 is stored in image-data storage section 12 in the form of radiograph data.

In the case of digital radiograph, radiograph -data producing section 10 is comprised of such an apparatus as a film digitizer for digitizing a film. And in the case of taking a digital photograph of a radiation picture, radiograph -data producing section 10 can be comprised of a digital imaging system such as CR system or the like. As far as radiation images can be provided, any one of the apparatuses mentioned above can be used.

Image-data storage section 12 is a section for storing radiograph data and its information such as patient's ID, image's ID, date of taking the picture or the like.

Image-data reading section 14 is a section for reading out, from image-data storage section 12, such information as prescribed radiograph data to be diagnosed and trace-read and information about an image such as patient's ID, image's ID or the like. These read-out information are used for displaying them on image data display section 16.

Image-data display section 16 is a section for displaying the radiograph data. A display apparatus comprising CRT, a plasma display, a liquid-crystal display or the like is used in the present invention. And these display apparatuses are called “display device” as a generic name, in the present invention. Furthermore, as the image display apparatus of the embodiment of the present invention is used for medical applications, a display screen having highly fineness CRT having more than 1,000 scanning lines is preferably used.

Image-data reading section 14 reads out data such as radiograph data etc. from image-data storage section 12 where the radiograph data or the like are stored, and sends the data to image-data display section 16, thereby the radiograph is displayed on the display screen of the display device of the image-data display section 16.

Data input device 18 is an input device for inputting a demand in relation to the radiograph displayed on the display device, into the image data displaying apparatus, in order, for example, to set up an image reading window, to process the radiograph displayed within the image reading window or the like.

A mouse is generally used and reasonable one as data input device 18, but a touch panel, keyboard or the like can also be used for the mouse.

Image-reading-window setting section 20 is a section for dealing with a demand from data input device 18 and for setting up the image reading window, in order to control a region of the image displayed on image data display section 16. Image-reading-window setting means is comprised of data input device 18 and image-reading-window setting section 20.

Image-reading-window shifting section 22 is a section for dealing with a demand from data input device 18, to thereby control an amount of a shift of the image reading window. Image-reading-window shifting means is comprised of image-reading-window shifting section 22 and data input device 18.

Image-reading-window-size changing section 24 is a section for dealing with a demand from data input device 18, to thereby control the change of the size of the image reading window. That is, image-reading-window-size changing means is comprised of image-reading-window-size changing section 24 and data input device 18.

Image-reading-window-shape changing section 26 is a section for dealing with a demand from data input device 18, to thereby control the change of the shape (rectangular, circular or the like) of the above mentioned image reading window. Image-reading-window-shape changing means is comprised of image-reading-window-shape changing section 26 and data input device 18.

Image data processing section 28 is a section for dealing with a demand from data input device 18, to thereby process the image displayed only on the screen of the above mentioned image reading window, for example contrast enhancing, window processing, frequency enhancing etc. Therefore, image data processing means is comprised of image data processing section 28 and data input device 18.

The above mentioned image-reading-window setting means controls the region of the displayed image by setting up the “image reading window” in image display section 16 displaying the radiation image which is read out from image data storage section 12 through image-data reading section 14.

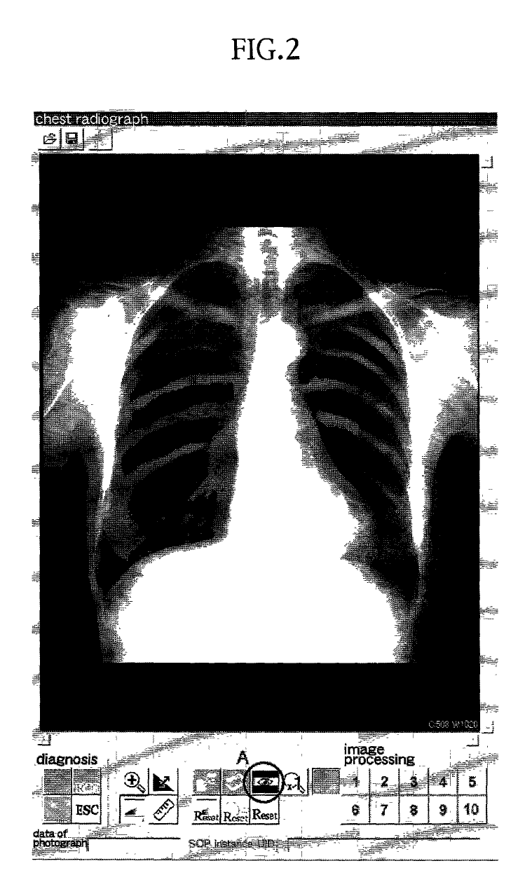

In the embodiment of the present invention, data input device 18 is a mouse. In a case that data input device 18 is a mouse, “image reading window” for controlling the region of the displayed image can be set up by pushing an “image-reading-window setting ” button (referred to A button in FIG. 2, a bitmap button having the same function is used here).

When the “image-reading-window setting” button is pushed down, said image-reading-window setting section 20 displays only a portion of an image in the “image reading window” on the screen of image data display section 16. A default position, size or shape of the “image reading window” is controlled by image-reading-window setting section 20. And the region except the “image reading window” is masked.

In the embodiment of the present invention, the domain other than the “image reading window” is covered by black mask.

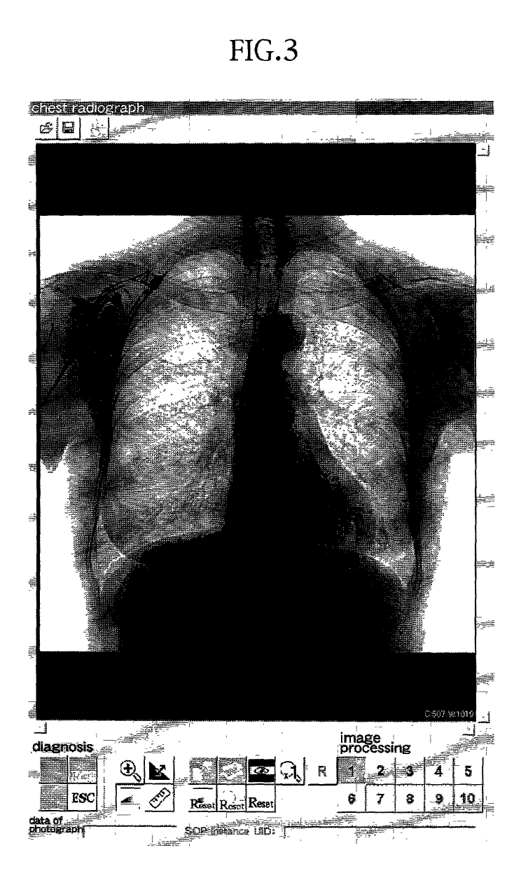

FIG. 2 and FIG. 3 show examples of pictures (the “image reading window” is not yet set up) displayed on the screen of image data display section 16, in line with reading image data and image information from image-data storage section 12 through image-data reading section 14. Brightness of a under portion of the diaphragm is brighter than that of the lung region in FIG. 2 and brightness of the outside of the body silhouette is brighter than that of the lung region, so that there is a possibility that visual sensitivity to the lung region tends to be deteriorated.

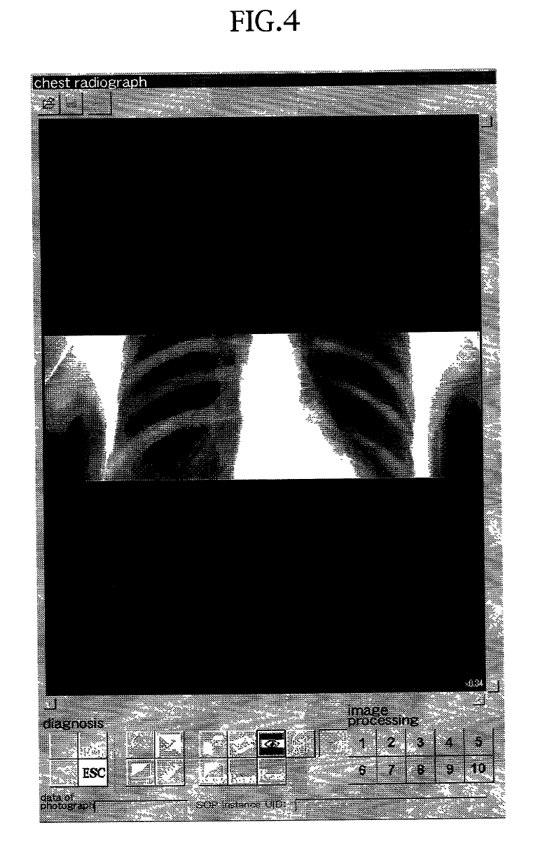

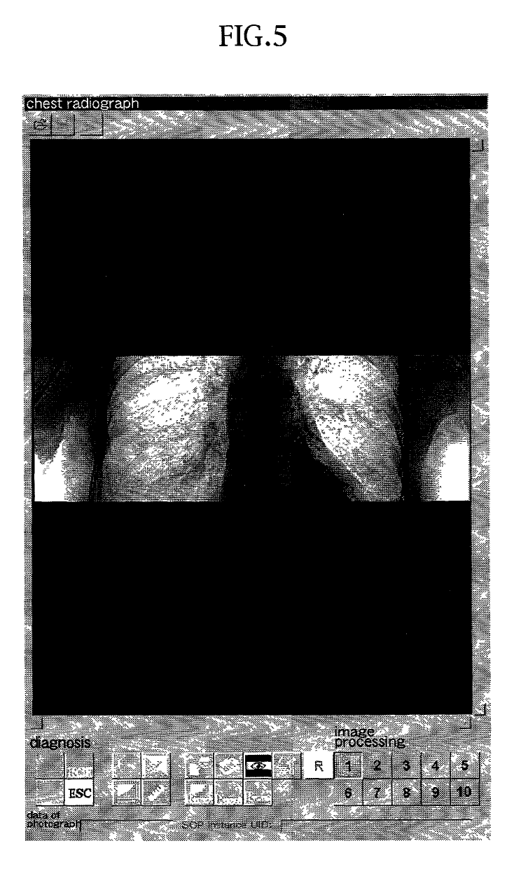

FIG. 4 and FIG. 5 show examples of pictures displayed on the screen of image data display section 16. The region in which an image is displayed is controlled by setting up the “image reading window.” Rectangular type “image reading windows” are set up in relation to FIG. 2 and FIG. 3 respectively. Visual sensitivity for the lung regions are improved in FIG. 4 in which the under portion of the diaphragm is masked so as not to be displayed and in FIG. 5 the outside of the body silhouette is masked so as not to be displayed respectively. Therefore, accuracy of diagnosis is expected to be improved.

Next, operation of the image-reading-window shifting means will be explained.

Setting position of “image reading window” is changed by data input device 18 that gives orders of a shifting direction and a shifting distance to image-reading-window shifting section 22.

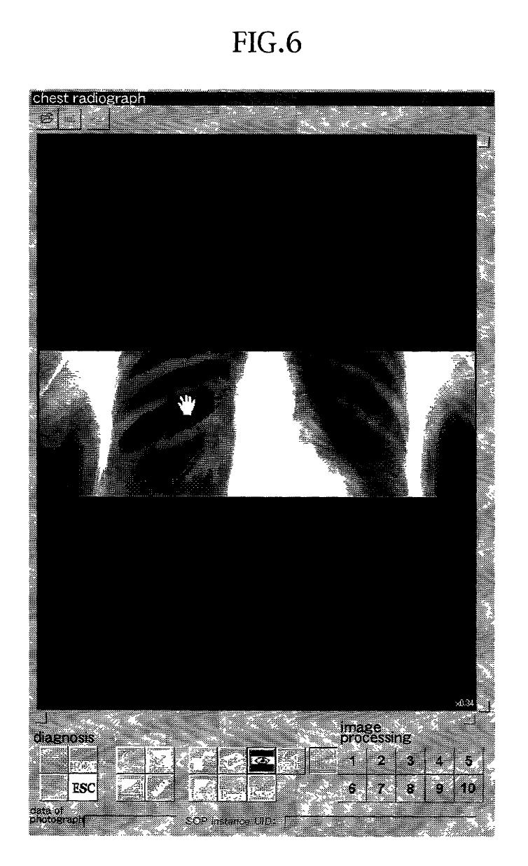

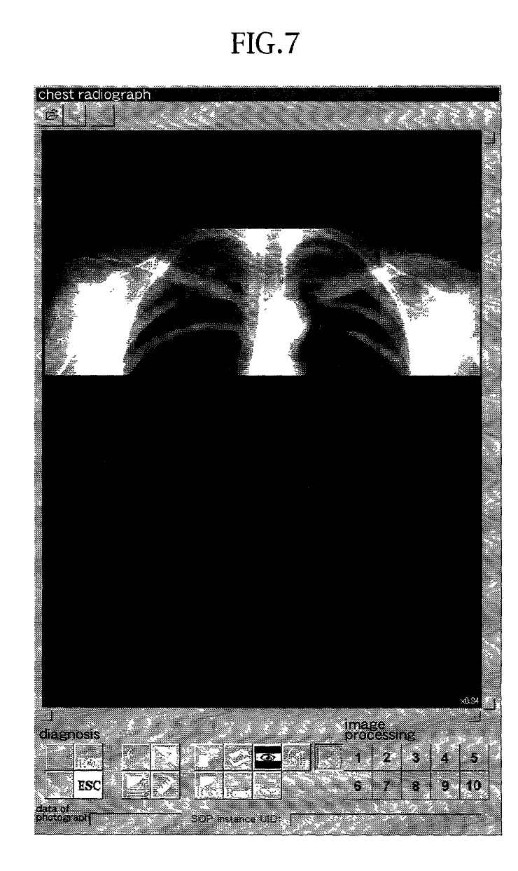

When data input device 18 is a mouse, the setting position of the “image reading window” can be arbitrarily changed by dragging the mouse point within the “image reading window” with the mouse. As shown in FIG. 6, the setting position of the “image reading window” can be shifted upward by dragging a mouse point that is shown as a hand mark. FIG. 7 shows a picture after the image reading window is shifted.

Image-reading-window shifting section 22 determines a next location of the “image reading window” based on an order of a shifting direction and a shifting distance of the “image reading window”, which is given by data input device 18. Then newly determined location of the “image reading window” is displayed and other region except for the next location is masked. The domain other than the shifted “image reading window” is covered by a black mask.

The image-reading-window-size changing means re-sets the size of the “image reading window” by changing the size of the “image reading window” when the “image reading window” is set up on the radiograph.

The size of the “image reading window” is changed by giving an order of a changing size from data input device 18 to image-reading window-size changing section 24.

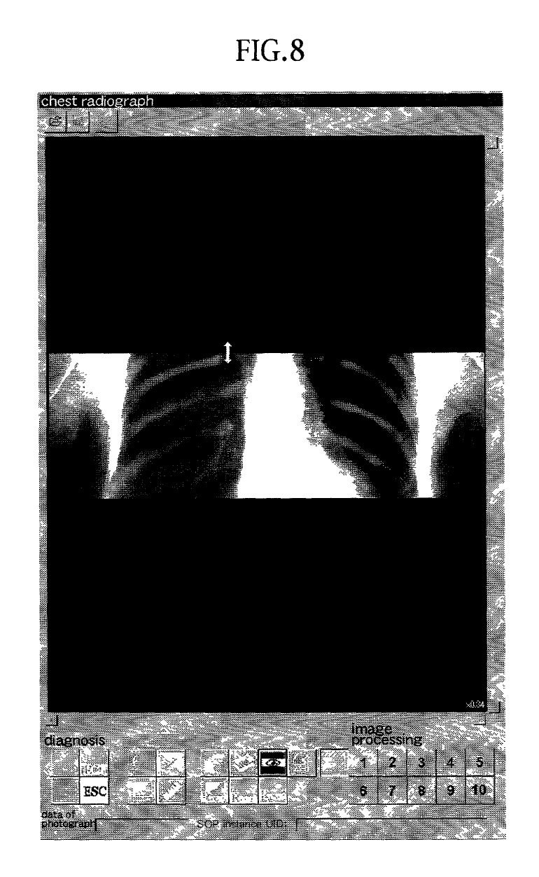

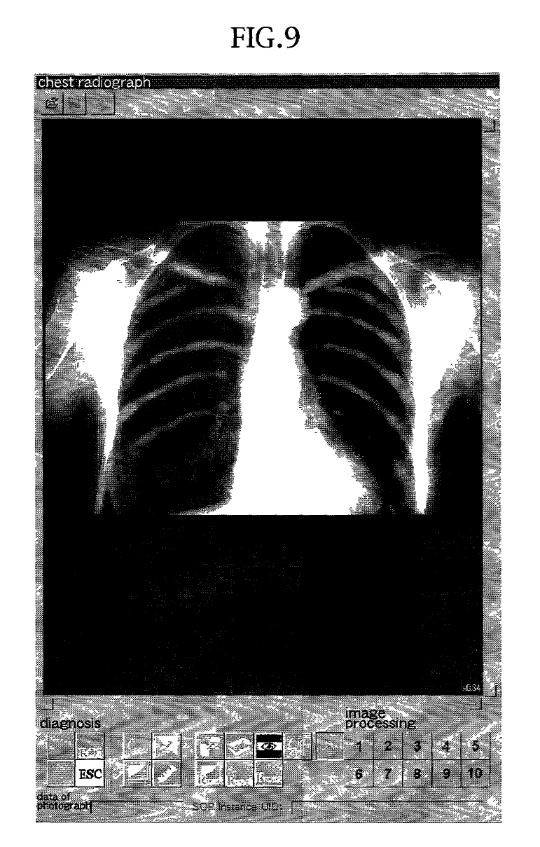

When a mouse is used as data input device 18, the size of the “image reading window” can be arbitrarily changed by dragging a border of the “image reading window” with the mouse. As shown at the border of the image in FIG. 8, the size of the “image reading window” can be changed, by dragging the mouse point that is shown as an arrow mark, with the mouse. A screenshot changed in size is shown in FIG. 9.

The size and position to be changed to of the “image reading window” is calculated by image-reading-window-size changing section 24 by dealing with information such as a ratio of increase or decrease in size and an original position thereof, that are given by data input device 18. Then only a newly determined “image reading window” is displayed, and other region except newly determined “image reading window” is not displayed. As shown in FIG. 8 and FIG. 9, the domain other than the changed “image reading window” is covered by a black covering mask.

Image-reading-window-shape changing means changes the shape of the “image reading window” and resets the shape when the “image reading window” is set up in relation to a radiograph.

The shape of the “image reading window” is changed by giving shape information from data input device 18 to image-reading-window-size changing section 26.

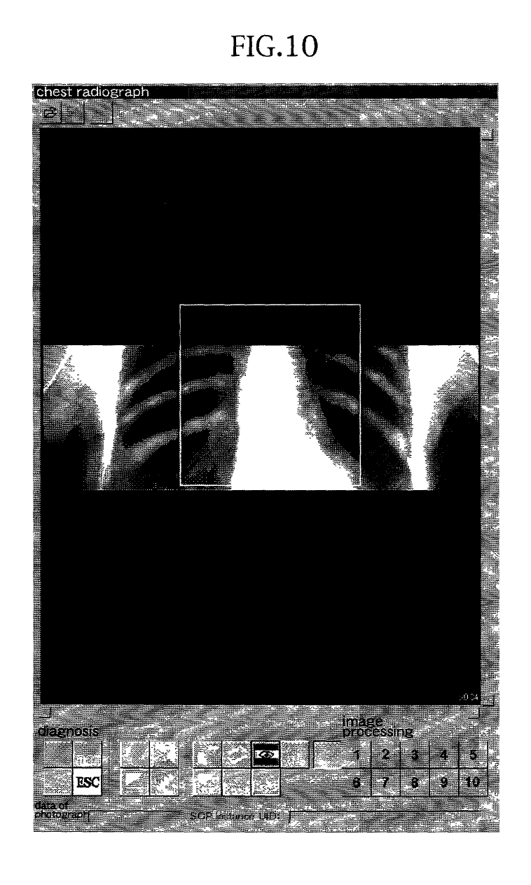

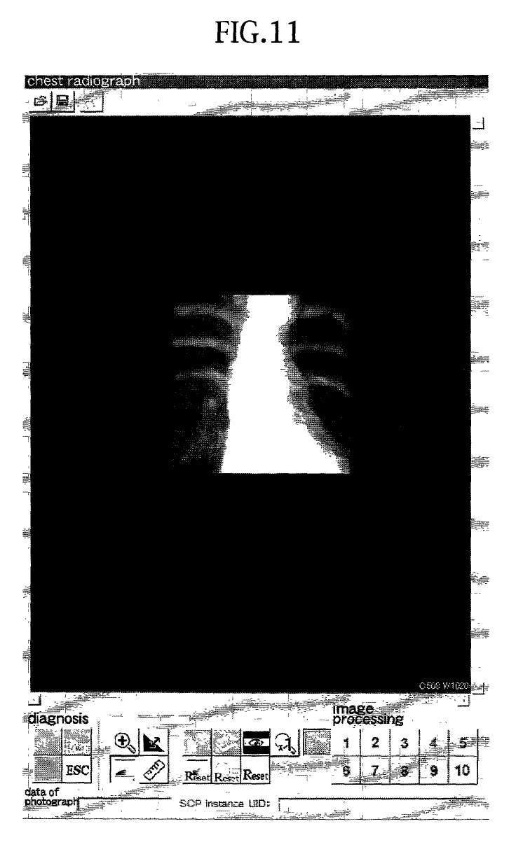

When data input device 18 is a mouse, the shape of the “image reading window” can be arbitrarily changed by dragging a mouse point in the domain of the image with the mouse and setting a desired shape. FIG. 10 is a picture in which the “image reading window” is instructed to be changed. The picture shows a stage of changing the shape of the “image reading window” from a rectangular shape to a square shape that is indicated by a white line. FIG. 11 shows a picture of a new “image reading window” after changed in shape.

The shape of the “image reading window” is calculated by image-reading-window-shape changing section 26 on the basis of the shape of the “image reading window,” which is given by data input device 18. Then, only the newly determined image of the “image reading window” is displayed on the screen and other region other than the newly determined “image reading window” is masked. As shown in FIG. 11, other region other than the “image reading window” which has changed in shape is covered with a black covering mask.

Image-data-processing means of image reading window is means for processing an image only in relation to an image data of the image domain which is displayed in the “image reading window”, when the “image reading window” is set up on a radiograph.

Image processing such as contrast enhancing, window processing, frequency enhancing or the like is performed in relation to a radiograph displayed in the “image reading window”, by sending a demand about the image processing from data input device 18 to image data processing section 28.

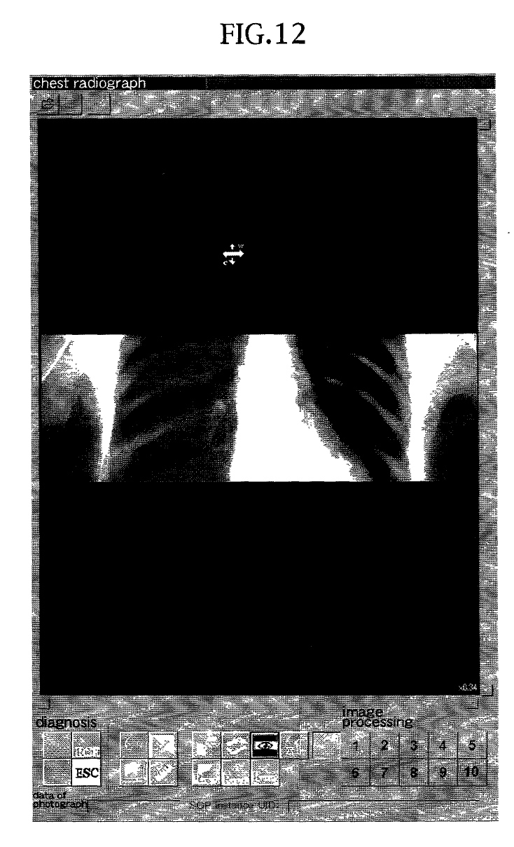

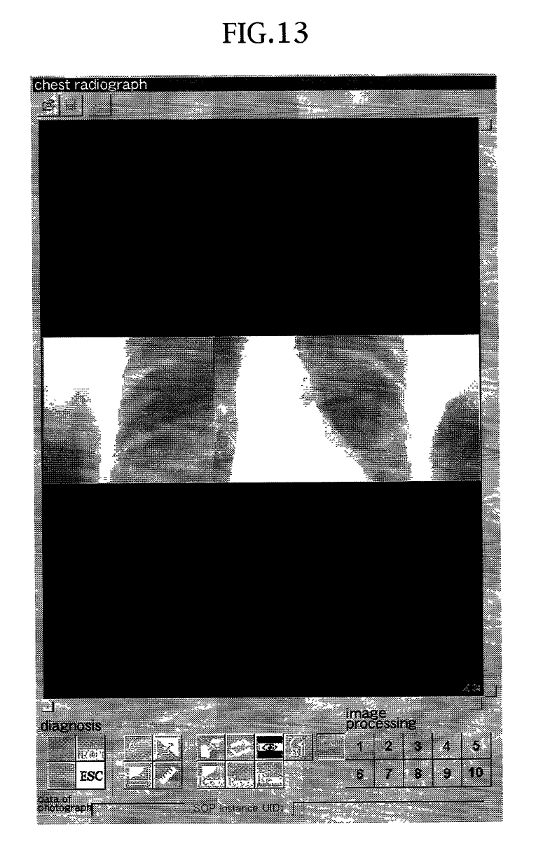

When data input device 18 is a mouse, image processing is performed only in relation to image data, which is displayed in the “image reading window,” by dragging the outside of the “image reading window” with the mouse. For example, as shown in FIG. 12, a mouse point of crisscross type in a region which is masked is a contrast changing mark. Contrast of the “image reading window” can be changed by dragging the contrast changing mark with the mouse. FIG. 13 is a picture after contrast is changed.

Other image processings can be performed by giving other demands to image data processing section 28, with allocating various kinds of processing to buttons or the like on the screen. For example, buttons 1 to 10 in FIG. 13 can be allocated to various kinds of processing.

Location, size and shape of the “image reading window” are not restricted to the patterns mentioned above. And it is desirable that various other patterns can be customized as operators like. Default setting is set up beforehand at image-reading-window setting section 20, but it is desirable that the default setting can be changed freely in the course of diagnosis or image reading procedure.

A feature of the present invention is that physical relationship in an image in relation to the direction of right and left or upper and lower can be precisely determined by making the shape of the “image reading window” rectangular or square. Furthermore, in such a symmetrical image in relation to right and left as a chest image or the like, differences between right and left portion of the image structure can be easily found out. Therefore, diagnosis can be performed accurately.

The present invention is not limited to the embodiment mentioned above and is applicable to other devices by modifying the embodiment of the present invention.

For example, location or layout of or images on the screen are not limited to the embodiments of the present invention. Though input of commands and selection of images are carried out by pushing buttons of a mouse in the present invention, the present invention is not limited to these processes or methods.

Location or layout of buttons on the screen can be arranged in a different fashion, and different information can also be displayed on the screen.

For example, a thumbnail image can be displayed on the button so that users can easily imagine the role of the buttons, to thereby the users can operate the device more easily.

Furthermore, embodiments in the present invention are explained about radiation images, but other images such as ultrasonic images, or Infra-Red images or the like are also certainly applicable to the present invention.

What is claimed is:

1. An image display apparatus comprising:
an image-data storage section for storing a data of a radiograph and other image data;
an image-data display section for displaying specified image data which is read from the image data storage section;
wherein an image reading window is formed on a screen of the image displaying section for displaying an image of a target region to be diagnosed or to be trace-read, and an image-reading-window setting means is provided for not displaying an image other than the target region to be diagnosed or to be trace-read.

2. An image display apparatus according to claim 1, further comprising an image-reading-window shifting means for shifting a setting position of the image reading window formed on the display screen.

3. An image display apparatus according to claim 1 or 2, further comprising an image-reading-window-size changing means for changing a size of the image reading window formed on the display screen.

4. An image display apparatus according to one of the claims of 1 to 3, further comprising an image-reading-window-shape changing means for changing a shape of the image reading window formed on the display screen.

5. An image display apparatus according to one of the claims of 1 to 4, wherein the shape of the image reading window is rectangular or square.

6. An image display apparatus according to one of the claims of 1 to 5, further comprising an image processing means for processing the image in relation to the image data displayed on the image reading window.

7. An image display apparatus comprising:
a data storage section for storing a data of an image;
an image display section for displaying a specified image, the specified image being based on a specified data of the image, that is sent from the data storage section;
an image reading window for displaying a target region to be checked in the specified image; and
an image-reading-window setting means for not displaying an image other than the target region to be checked.

8. An image display apparatus according to claim 7, further comprising an image-reading-window shifting means for shifting the image reading window.

9. An image display apparatus according to claim 7, further comprising an image-reading-window-size changing means for changing the size of the image reading window.

10. An image display apparatus according to claim 7, further comprising an image-reading-window-shape changing means for changing a shape of the image reading window.

11. An image display apparatus according to claim 7, further comprising an image-data processing means for changing image quality of the image.
